(19) United States
(12) Patent Application Publication
(10) Pub. No.: US 2012/0319915 A1
(43) Pub. Date: Dec. 20, 2012

(54) Helix Feed Broadband Antenna Having Reverse Center Feeder

(75) Inventors: Wan Lae Roh, Daejeon (KR); Chan Goo Park, Daejeon (KR)

(73) Assignee: WIWORLD CO., LTD., Daejeon (KR)

(21) Appl. No.: 12/994,244

(22) PCT Filed: May 25, 2010
(86) PCT No.: PCT/KR2010/003273

§ 371 Date: Nov. 23, 2010

(30) Foreign Application Priority Data
Jul. 15, 2009 (KR) 10-2009-0064601

(51) Int. Cl. H01Q 19/10; H01Q 19/12

(52) U.S. Cl. 343/840; 343/834

(57) ABSTRACT

Provided is a helix feed broadband antenna having a reverse center feeder, which minimizes an antenna enclosure and a radio wave shadow area by using the reverse center feeder including a reflecting plate and a rear radiation pattern, thereby enhancing performance of an antenna. The helix feed broadband antenna having a reverse center feeder, including a reverse center feeder which radiates an antenna radiation pattern backward; and a reflecting plate which is positioned at a rear side of the reverse center feeder so as to receive and transmit radio wave by reflecting an antenna beam radiated from the reverse center feeder.

### TECHNICAL FIELD

The present invention relates to an antenna having a reverse center feeder, and particularly, to a helix feed broadband antenna having a reverse center feeder, which minimizes an antenna enclosure and a radio wave shadow area by using the reverse center feeder including a reflecting plate and a rear radiation pattern, thereby enhancing performance of an antenna.

### BACKGROUND ART

Generally, in a parabolic antenna that is also called as a dish antenna, a reflecting plate is formed of a metal plate, and a main antenna is disposed at a focus thereof. According to an operation of the reflecting plate, it has a strong directivity in an axial direction thereof, and thus it is characterized by having excellent efficiency without being interfered. Therefore, since the radio wave is converged in one direction and strongly radiated, it is widely used to linearly transmit the radio wave from one point to the other point like in TV broadcast.

When the parabolic antenna is used as a receiving antenna, the radio wave arriving at the reflecting plate is reflected and collected on the focus, and thus the directivity of the antenna is very high. In case that the parabolic antenna is formed into a circular shape, the directivity thereof is proportional to a surface area of the reflecting plate. That is, as a size of the reflecting plate becomes larger, the performance of receiving and transmitting the radio wave is increased.

The parabolic antenna is classified into a prime focus type and a ring focus type. The prime focus type parabolic antenna includes a Gregory antenna and a Cassegrain antenna, and the ring focus type parabolic antenna includes an ADE antenna. In the Cassegrain antenna, a common focus of a main reflecting plate and a sub-reflecting plate is formed as a virtual focus, and in the Gregory antenna, the common focus is formed as a real focus.

FIG. 1 is a view showing of a conventional Cassegrain antenna.

The Cassegrain antenna includes a main reflecting plate 110, a feeder 120 and a sub-reflecting plate 130. An antenna beam which is propagated through the feeder 120 is reflected by the sub-reflecting plate 130 is delivered to the main reflecting plate 110. The antenna beam delivered to the main reflecting plate 110 is reflected by the main reflecting plate 110 and the propagated to an outside. The antenna beam propagated to the outside has strong directivity because of the reflection of the sub-reflecting plate 130 and the main reflecting plate 110. However, in case of the Cassegrain antenna, since the sub-reflecting plate 130 is placed in a direction that the antenna beam is propagated, there is a problem that a radio wave shadow area 140 corresponding to a cross-sectional area of the sub-reflecting plate 130 is formed. Further, since a supporter is separately needed to install the sub-reflecting plate 130, it has a complicated structure. Furthermore, since the radio wave shadow area may be additionally formed due to the complicated structure, it is difficult to manufacture the antenna, and thus a manufacturing cost is increased, and antenna performance is deteriorated.

FIG. 2 is a view of a conventional parabolic antenna having a center feeder.

A parabolic antenna having a center feeder includes a reflecting plate 210, a center feeder 220 and one or more feeder supporter 221. An antenna beam from the center feeder 220 is reflected by the reflecting plate 210 and then propagated to an outside. However, in case of the parabolic antenna having the center feeder, there is a problem that a radio wave shadow area 230 corresponding to a cross-sectional area of the center feeder 220 is formed. Further, since one or more feeder supporter 221 for connecting the center feeder 220 and the reflecting plate 210 is needed to support the center feeder 220, the radio wave shadow area is additionally formed, and thus the antenna performance is deteriorated.

Therefore, to solve the problems of the conventional parabolic antenna, it is required to provide a new technology for minimizing the antenna enclosures and thus the radio wave shadow area and also enhancing the antenna performance.

### DISCLOSURE

### Technical Problem

An object of the present invention is to provide a helix feed broadband antenna having a reverse center feeder, which can simplify an antenna enclosure without a sub-reflecting plate and a center feeder and also can minimize a radio wave shadow area by using the reverse center feeder including a reflecting plate and a rear radiation pattern, thereby enhancing performance of an antenna.

### Technical Solution

To achieve the object of the present invention, the present invention provides a helix feed broadband antenna having a reverse center feeder, including a reverse center feeder which radiates an antenna radiation pattern backward; and a reflecting plate which is positioned at a rear side of the reverse center feeder so as to receive and transmit radio wave by reflecting an antenna beam radiated from the reverse center feeder.

Preferably, the reflecting plate is a dish-shaped parabolic antenna.

Preferably, the reverse center feeder includes an antenna feeder for forming the antenna radiation pattern which is radiated backward; and a second supporter which comprises a ground surface connected with the antenna feeder and supports the antenna feeder to be fixed to the reflecting plate.

Preferably, in case that the feeder supporter is formed into a cylindrical shape, a diameter of a ground surface connected with the antenna feeder has a value that is less than a half of a wavelength of the radio wave radiated backward from the antenna feeder, and in case that the feeder supporter is formed into a polygonal pole, a maximum diagonal line of the ground surface connected with the antenna feeder has a value that is less than a half of a wavelength of the radio wave radiated backward from the antenna feeder.

Preferably, the reverse center feeder includes a helix feeder which forms the antenna radiation pattern; and a first supporter which is connected with second supporter and supports the helix feeder to be protruded from the second supporter and fixed in a spiral shape, and the second supporter is formed into a cylindrical shape, and a diameter of a ground surface of the second supporter has a value that is less than a half of a wavelength of the radio wave radiated backward from the antenna feeder.

### Advantageous Effects

According to the present invention, it is possible to simplify an antenna enclosure without a sub-reflecting plate and a center feeder and also minimize the radio wave shadow area by using the reverse center feeder including the reflecting plate and the rear radiation pattern, thereby enhancing performance of the antenna.

### DESCRIPTION OF DRAWINGS

The above and other objects, features and advantages of the present invention will become apparent from the following description of preferred embodiments given in conjunction with the accompanying drawings, in which:

FIG. 1 is a schematic view of a conventional Cassegrain antenna.

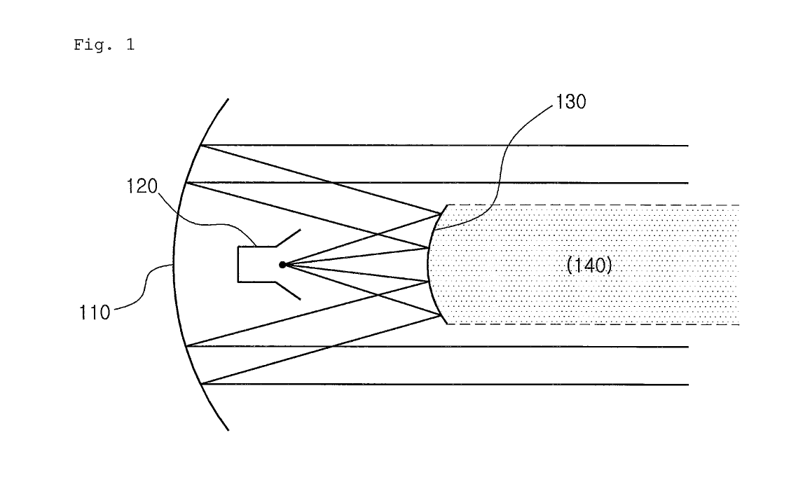

FIG. 2 is a schematic view of a conventional parabolic antenna having a center feeder.

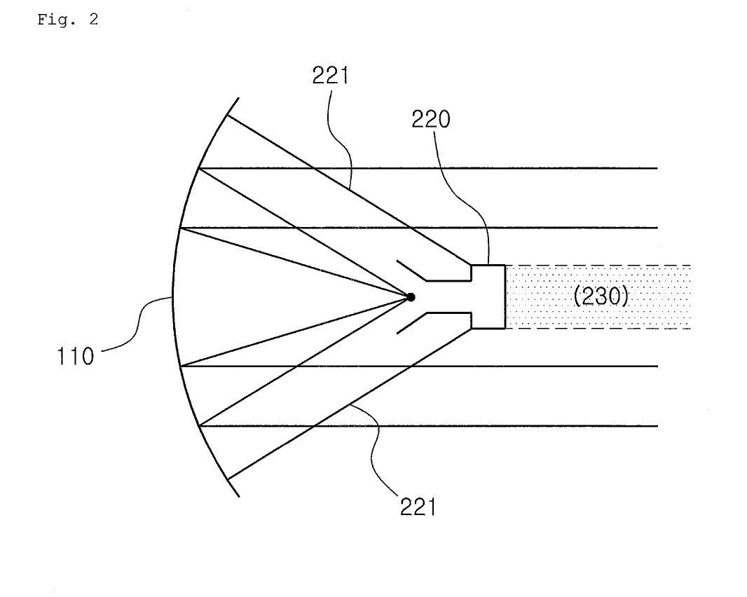

FIG. 3 is a view showing a construction of a helix feed broadband antenna having a reverse center feeder in accordance with an embodiment of the present invention.

FIG. 4 is a view of a rear radiation pattern of an antenna beam of the helix feed broadband antenna having the reverse center feeder in accordance with an embodiment of the present invention.

### DETAILED DESCRIPTION OF MAIN ELEMENTS

311: helix feeder
312: first supporter
320: second supporter
330: reflecting plate

### BEST MODE

Hereinafter, the embodiments of the present invention will be described in detail with reference to accompanying drawings.

An antenna having a reverse center feeder according to the present invention includes the reverse center feeder and a reflecting plate. In the antenna having the reverse center feeder, the reflecting plate may be formed into a dish-shaped parabolic antenna.

In the reverse center feeder, an antenna radiation pattern may be a rear radiation pattern. The reflecting plate is positioned at a rear side of the reverse center feeder so as to receive and transmit radio wave through reflection of an antenna beam which is radiated backward from the reverse center feeder.

The reverse center feeder includes an antenna feeder and a feeder supporter. By the antenna feeder, the antenna radiation pattern may be formed into the rear radiation pattern. The feeder supporter includes a ground surface, which is connected with the antenna feeder, and also supports the antenna feeder so as to be fixed to the reflecting plate.

The ground surface of the feeder supporter is a cross section of a portion that is connected with the antenna feeder. The ground surface may be formed into a circular or polygonal shape according to a shape of the feeder supporter. In case that the feeder supporter is formed into a cylindrical shape, a diameter of a circular ground surface has a value that is less than a half of a wavelength of the radio wave emitted through the antenna feeder. Further, in case that the feeder supporter is formed into a polygonal pole, a maximum diagonal line of the ground surface formed into a polygonal shape has a value that is less than a half of a wavelength of the radio wave emitted through the antenna feeder.

That is, in order for the antenna beam to be radiated backward, the diameter or the maximum diagonal line of the ground surface may be formed to have the value that is less than a half of the wavelength of the radio wave. For example, in case of using a frequency of 2 GHz, a wavelength corresponding to the frequency may be set to a value of 15 cm that is calculated by dividing a propagation velocity by the frequency. In this case, the diameter or the maximum diagonal line of the ground surface may be set to a value of 7.5 cm or less in order for the antenna beam to be radiated backward.

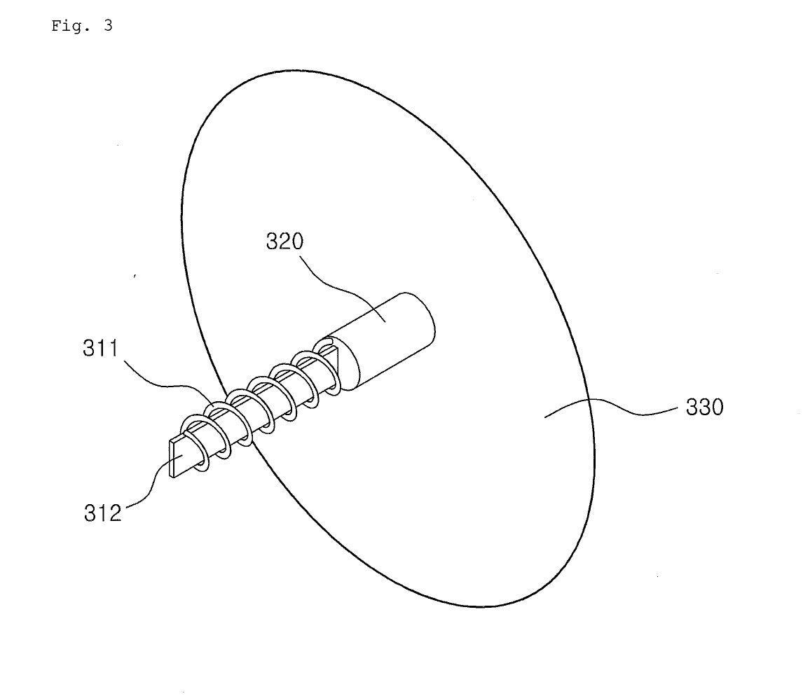

FIG. 3 is a view showing a construction of a helix feed broadband antenna having a reverse center feeder in accordance with an embodiment of the present invention.

A helix feed broadband antenna having a reverse center feeder according to the present invention includes a helix feeder 311, a first supporter 312, a second supporter 320 and a reflecting plate.

The helix feeder 311 is disposed to be connected with the second supporter 320 and fixed through the first supporter 312.

The first supporter 312 is connected with the second supporter 320 and also supports the helix feeder 311 to be protruded from the second supporter 320 and fixed in a spiral shape. For example, as shown in FIG. 3, the first supporter 312 may be formed into a thin rectangular stick shape and connected with the second supporter 320, and the helix feeder 311 may be fixedly attached to the first supporter 312 so as to surround the first supporter 312.

The second supporter 320 may be formed into a cylindrical shape. Therefore, a ground surface of the first supporter 320 that is connected with the helix feeder 311 and the first supporter 312 may be formed into a circular shape. In order for the antenna beam radiated from the helix feeder 311 to be emitted backward,

A diameter of the ground surface of the second supporter 320 may be set to a value that is less than a half of a wavelength of the antenna beam.

The helix feeder 311 forms an antenna radiation pattern.

### The Antenna Radiation Pattern

Further, in case that the feeder supporter is formed into a polygonal pole, a maximum diagonal line of the ground surface formed into a polygonal shape has a value that is less than a half of a wavelength of the radio wave emitted through the antenna feeder.

The helix feeder 311 forms the antenna radiation pattern. Since the diameter of the ground surface of the second supporter 320 is set to have the value that is less than a half of the wavelength of the radio wave emitted through the antenna radiation pattern, the antenna radiation pattern formed from the helix feeder 311 according to an embodiment of the present invention is radiated backward in a direction of the reflecting plate 330. Therefore, the antenna beam emitted from the helix feeder 311 is reflected by the reflecting plate 330 and then propagated to an outside.

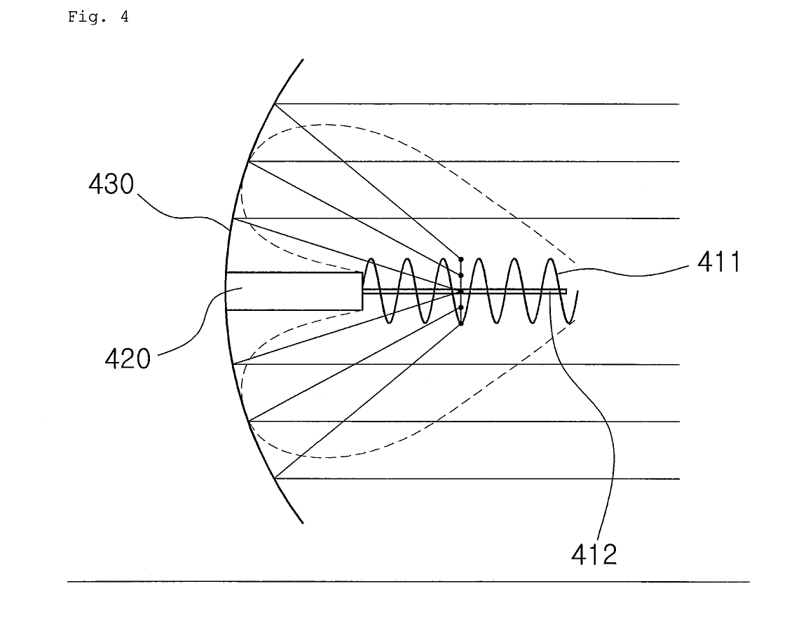

FIG. 4 is a view of a rear radiation pattern of an antenna beam of the helix feed broadband antenna having the reverse center feeder in accordance with an embodiment of the present invention.

The helix feed broadband antenna having the reverse center feeder according to an embodiment of the present invention includes a helix feeder 411, a first supporter 412, a second supporter 420 and a reflecting plate 430.

The helix feed broadband antenna having the reverse center feeder according to the embodiment of the present invention may be formed into a ring focus type. That is, as shown in FIG. 4, an antenna beam may be focused through a ring focus in which a plurality of focuses are disposed in the form of a ring.

Further, as shown in FIG. 4, the antenna beam radiated from the helix feeder 411 is radiated backward in a direction of the reflecting plate 430 which is positioned at a rear side of the helix feeder 411. Therefore, the antenna beam that is radiated backward is reflected by the reflecting plate 430 and propagated in a direction that the reflecting plate 430 is directed.

The present application contains subject matter related to Korean Patent Application No. 2009-0064601, filed in the Korean Intellectual Property Office on Jul. 15, 2009, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

As described above, since the helix feed broadband antenna having the reverse center feeder according to the present invention can be constructed by only the reflecting plate and the reverse center feeder without a sub-reflecting plate, the number of the antenna enclosures are minimized to thereby reduced the manufacturing cost. Further, it is possible to minimize the radio wave shadow area, thereby improving the performance of receiving and transmitting the radio wave.

Further, in case that the reverse center feeder is the helix feeder, the ring focus may be embodied by the helix feeder. In case of an AED antenna that the ring focus is embodied, it is necessary to a sub-reflecting plate having two curved surfaces. On the other hand, since the antenna having the reverse center feeder according to the present invention is a ring focus type without the sub-reflecting plate, it is possible to minimize the radio wave shadow area formed by the sub-reflecting plate and also to obtain further improved performance of receiving and transmitting the radio wave.

Furthermore, in case that the reverse center feeder is the helix feeder, the antenna beam pattern is radiated backward, and also it is possible to change a direction of circular polarization. However, since the circular polarization is reflected by the reflecting plate and then propagated to the outside, the direction of the polarization may be changed once again, when being reflected by the reflecting plate. Therefore, since the polarization rotation direction of the circular polarization may be embodied to be the same as an initial polarization rotation direction radiated from the helix feeder, the polarizations radiated from or received in the feeder and the reflecting plate are coincided with each other, and thus it is impossible to ensure an intuition in analyzing the polarizations.

1. A helix feed broadband antenna having a reverse center feeder, comprising:
a reverse center feeder which radiates an antenna radiation pattern backward; and
a reflecting plate which is positioned at a rear side of the reverse center feeder so as to receive and transmit radio wave by reflecting an antenna beam radiated from the reverse center feeder.

2. The helix feed broadband antenna of claim 1, wherein the reflecting plate is a dish-shaped parabolic antenna.

3. The helix feed broadband antenna of claim 1, wherein the reverse center feeder comprises:
an antenna feeder for forming the antenna radiation pattern which is radiated backward; and
a second supporter which comprises a ground surface connected with the antenna feeder and supports the antenna feeder to be fixed to the reflecting plate.

4. The helix feed broadband antenna of claim 3, wherein, in case that the feeder supporter is formed into a cylindrical shape, a diameter of a ground surface connected with the antenna feeder has a value that is less than a half of a wavelength of the radio wave radiated backward from the antenna feeder, and in case that the feeder supporter is formed into a polygonal pole, a maximum diagonal line of the ground surface connected with the antenna feeder has a value that is less than a half of a wavelength of the radio wave radiated backward from the antenna feeder.

5. The helix feed broadband antenna of claim 3, wherein the reverse center feeder comprises:
a helix feeder which forms the antenna radiation pattern; and
a first supporter which is connected with second supporter and supports the helix feeder to be protruded from the second supporter and fixed in a spiral shape, and
the second supporter is formed into a cylindrical shape, and a diameter of a ground surface of the second supporter has a value that is less than a half of a wavelength of the radio wave radiated backward from the antenna feeder.
